(19) United States
(12) Patent Application Publication
(10) Pub. No.: US 2010/0061094 A1
(43) Pub. Date: Mar. 11, 2010

(54) LIGHT GUIDE ARRANGEMENT WITH STITCHED WIRE

(75) Inventors: Willem L. Ijzerman, Eindhoven (NL); Michel C.J.M. Vissenberg, Eindhoven (NL); Stefan M. Verbrugh, Eindhoven (NL); Peter H.F. Deurenberg, Eindhoven (NL)

Correspondence Address: Philips Intellectual Property and Standards, P.O. Box 3001, Briarcliff Manor, NY, 10510-8001, US

(73) Assignee: Koninklijke Philips Electronics N.V., Eindhoven (NL)

(21) Appl. No.: 12/439,801

(22) PCT Filed: Sep. 24, 2007
(86) PCT No.: PCT/IB2007/053865

§ 371 Date: Mar. 3, 2009

(30) Foreign Application Priority Data
Sep. 26, 2006 (EP) 06121263.5

(51) Int. Cl. F21V 1/00; F21S 8/10

(52) U.S. Cl. 362/235; 362/317; 362/311.01

(57) ABSTRACT

A light guide arrangement comprising a light guide (101) provided with through holes (103), multiple light source sites (117) and out coupling structures (119) for directing light out from the light guide. There is at least one wire (105a) and each wire is provided along a sequence (103a-103d) of through holes in the light guide. At each through hole in the sequence, a first wire portion (108a) extends from a first side of the light guide and is in engagement with a second wire portion (110a) extending from a second side. Wires that are stitched like this allow for a low degree of optical contact with the light guide and thus allow wires and components to be attached without light leaking out undesirably. The wires are preferably electrically conducting wires. A luminarie comprises the light guide arrangement and light sources, and in a method for providing the wires to a light guide arrangement, the wires are sewed to the light guide.

### FIELD OF THE INVENTION

The present invention relates generally to a light guide arrangement comprising a light guide, multiple light source sites and out coupling structures. More specifically it relates to provision of wires to said arrangement.

### BACKGROUND OF THE INVENTION

A recent trend in luminaires is to replace large conventional light sources, such as fluorescent tubes, with a plurality of smaller light sources, in combination providing the required coverage and/or luminance. Owing to previous and ongoing progress and development in the area of light emitting diodes (LEDs), LEDs are presently an advantageous choice of such a small light source, although other alternatives may be found in the future.

LED based luminaires, in particular such for illumination of large areas, may contain large numbers of individual LEDs. In some applications several hundred LEDs may be used in a single luminaire. In order to spread light from multiple LEDs, which represent very small light source units, and accomplish a uniform luminous flux from a luminaire where individual light sources are not visible, the LEDs are arranged so that light is emitted into a light guide, in which the light is spread and mixed, before it is being directed out from the light guide by out coupling structures, such as reflecting facets.

One straightforward way is to use a printed circuit board (PCB) on which the LEDs are mounted and attach the PCB to the light guide (or vice versa). However, a PCB is relatively expensive, which e.g. makes it less attractive to replace conventional luminaires with LED-based ones. This issue is augmented if an even more expensive multi layered PCB is required, which may be the case when a more complex routing of the conductors is desired. A PCB is further non-transparent and thus per se light obstructing, and a luminaire can hence not be light emitting in the direction of the PCB.

If a PCB is not to be used, one is faced with the problem of how to electrically connecting the LEDs and how to physically connect the LEDs to the light guide. The LEDs can be electrically connected by use of separate electrical wires. However, in such case the wires need to be attached to the light guide.

Another problem is how to manufacture a luminaire where a lot of separate parts have to be attached to the light guide, i.e. without the parts being pre-attached to e.g. a PCB. This is potentially very time consuming and thus expensive.

Using an adhesive could be one solution, however, attaching things to a light guide using an adhesive results in too much of optical contact and light will be coupled out from the light guide in an undesired and uncontrolled manner. A uniform luminous flux can thus not be accomplished.

Generally, a luminaire should be able to provide a well-controlled, well-defined uniform luminous flux without unintentional spreading and/or obstruction of light. In particular, luminaires should be able to comply with application specific requirements, for example regarding glare. For example, in many applications, a glare related requirement is that the luminous flux should be uniform and not exhibit any bright spots, not even when the luminaire is viewed from certain oblique angles.

### SUMMARY OF THE INVENTION

It is an object of the present invention to overcome or at least alleviate problems in the prior art. A specific object is to provide a light guide arrangement for use with multiple small light sources, which arrangement allow for attaching wires with a low degree of optical contact. Another specific object is to allow for cost efficient manufacturing of such a light guide arrangement and a luminaire comprising said arrangement.

The invention is defined by the appended independent claims. Preferred embodiments are set forth in the dependent claims and in the following description and drawings.

Hence, according to a first aspect, the above-mentioned and other objects that will be evident from the following description, are achieved by a light guide arrangement that comprises a light guide provided with through holes extending between a first side and an opposite second side of said light guide, multiple light source sites arranged at said light guide and adapted to receive light sources so that said light sources emit light into said light guide, and out coupling structures arranged at said light guide and adapted to direct light out from said light guide. The light guide arrangement also comprises at least one wire, wherein each wire is provided along a sequence of said through holes, wherein, at each through hole in said sequence, a first wire portion extends from said first side and is in engagement with a second wire portion extending from said second side.

According to a second aspect, there is provided a method for providing wires to a light guide arrangement for multiple light sources. The method comprises the steps of providing a light guide, multiple light source sites arranged at said light guide and adapted to receive light sources so that said light sources emit light into said light guide, and out coupling structures arranged at said light guide and adapted to direct light out from said light guide; providing said light guide with through holes extending between a first side and an opposite second side of said light guide; providing at least one wire; and sewing each wire to the light guide so that each wire is provided along a sequence of said through holes, wherein, at each through hole in said sequence, a first wire portion extends from said first side and is in engagement with a second wire portion extending from said second side.

The wire is thus “stitch attached”, or “stitched”, to the light guide. Via the sequential engagements with wire portions from opposite sides of the light guide, the wire is attached to the light guide, but not to the material of the light guide per se, as would be the case if an adhesive, such as glue, was used. Note that wires being stitched according to the above may also, but not necessarily, at the same time attach additional components to the light guide, i.e. the wires can act as fastening means for these additional components, and still per se being stitched to the light guide. The stitched wires thus allow the light guide to act as a substrate, where components can be physically connected to the light guide using the wires.

Compared to an adhesive case, stitched wires, and any additional components being attached by the wire, are not in particularly tight contact with the light guide and there is little optical contact. Hence, the attached wire, and any additional component being attached by the wire, allow for a low degree of optical contact, i.e. that no, or very little light being coupled out from the light guide in an undesired and uncontrolled manner. This allows for a well controlled luminous flux from a luminaire employing the light guide arrangement, without light leaking out undesirably, e.g. in undesired directions. As a result it is easier to comply with many application specific requirements, such as glare related requirements.

Additional components that can be attached by the wire includes for example other wires, e.g. electrical ones, optical components, such as optical plates, additional light guides, light sources, electronic components etc

Moreover, note that stitched wires of this kind do not require any additional, potentially expensive and/or hazardous, material when the wires are attached to the light guide.

Furthermore, attaching the wires by sewing allows for an efficient automated manufacturing process which e.g. may be based on conventional sewing techniques and/or machinery.

The wires may be electrically conducting wires, i.e. be electrical conductors. Electrically conducting wires allow for wires that are able to provide power and/or signals to e.g. light source sites and/or to other components at the light guide arrangement that may be in need of electrical connectivity. For example, a wire providing electrical signals may be used for brightness and/or color adjustments of light sources.

Note that “electrically conducting wire” do not necessarily mean that there is a current flowing in said wire or that the wire is connected to a power or signal source, although this typically is advantageous.

The first wire portion and the second wire portion may belong to the same wire, which e.g. is the case when a wire is chain stitched. An alternative to this is that the first wire portion and the second wire portion belong to different wires, which e.g. is the case when wires are lock stitched.

There may be two wires that cross each other, which is one efficient way of providing coverage over a large surface area of the light guide. When the wires are electrically conducting, this is also an economically viable alternative instead of using a multi-layered PCB.

Further, the wires may cross at a light source site. This allows for access of multiple wires at the light source site, which in turn, when the wires are electrically conducting, allows light sources, although belonging to the same sequence, to connect to electrically different wires, and thus a physical distribution and a spread of electrically connected light sources over the light guide can be accomplished. Hence, in a situation when electrically connected light sources malfunction, e.g. due to problems in the electrical support, a broken wire, a broken light source in a serial connection etc., the impact on a luminous flux from a luminaire using the light guide arrangement can be reduced, or at least be made less noticeable. In general, more wires per light source site allows for light sources that are more electrically independent from adjacent neighbors and for light sources that can be controlled individually or in smaller groups. The total luminous flux resulting from the light sources can thus be made more robust against erroneous single light sources, bad wires, fault in supply, shorts etc.

A set of wires may be arranged in a parallel interrelationship. Parallel wires means that crossed wires can be avoided, which e.g. allows for use of non-insulated electrically conducting wires. Note that that the set of wires, or a subset thereof, can be provided along the same sequence of through holes, and/or at the same sequence of light source sites.

Moreover, the through holes may be adjacent to the light source sites. Adjacent e.g. involves cases where the through holes are close to or partly or fully overlap the light source sites on the light guide surface. Since wires are present at the through holes, this is one way of accomplishing electrical connectivity at the light source sites. When the through holes fully overlap the sites, separate sites for the through holes, which could cause undesired out coupling of light, can be avoided. Also, since sites for the light sources are typically in the form of recesses in the light guide, manufacturing of the through holes and the light source sites can be efficiently combined. The through holes may even be light source sites.

Also, the through holes may be formed in connection with the outcoupling structures. This is another way where separate sites for the through holes, which per se may cause undesired out coupling of light, can be avoided. Further, since the structures for coupling light out from the light guide typically are in the form of recesses in the light guide, manufacturing of the through holes and the out coupling structures can be efficiently combined.

Advantageously there may be a luminaire that comprises the light guide arrangement and where light sources are positioned at the light source sites. The light sources may further, before sewing each wire to the light guide, be positioned at the light source sites so that the light sources are arranged to cooperate with the through holes in the light guide. For example, the light sources may have been prepared with light source through holes for cooperation with the through holes in the light guide, or the light source may be provided with through holes in situ during the sewing step, and which through holes cooperate with the light guide through holes.

This allows for attaching the light sources to the light guide at the same time and in the same way as the wire, without much of extra effort. Physical and electrical connection of a light source can be made using the same wire when the wire is electrically conducting. Note that electrically conducting wires can be used both to provide electrical power and/or electrical signals, such as control signals, to the light sources.

Also, manufacturing can be made very efficient when both wires and light sources and/or other components are attached to the light guide arrangement by the sewing step.

After the sewing the wires, at least one wire may be cut at a light source site. This can be advantageous in particular when electrically conducting wires are used since each time an electrically separated wire is cut, two electrically separated parts, i.e. wires, are formed. Cutting a wire or wires thus allows for increasing the number of electrically separated wires and for creating different conducting patterns, even after the wires have been attached.

### BRIEF DESCRIPTION OF THE DRAWINGS

This and other aspects of the present invention will now be described in more detail, with reference to the appended drawings.

FIG. 1a is a schematic view in perspective of a light guide arrangement according to a first embodiment where parallel wires are stitched to a sheet shaped light guide structure via light source sites in the form of through holes.

FIG. 1b is a schematic top view of the light guide arrangement in FIG. 1

FIG. 1c is a schematic side view of the light guide arrangement in FIG. 1 and is showing a cross section of the light guide and a wire that is chain stitched.

FIG. 2 is a schematic side view of a light guide arrangement according to a second embodiment and is showing a cross section of a light guide similar to the one of FIG. 1c but where wires are lock stitched.

FIG. 3 is a schematic side view of a light guide arrangement according to a third embodiment and is showing a cross section of a light guide where electrical wires are lock stitched via through holes that are combined with out coupling structures in the light guide.

FIG. 4 is a schematic side view of a light guide arrangement according to a fourth embodiment and is showing a cross section of a light guide where wires are lock stitched via separate stitch specific through holes.

FIG. 5a is a schematic top view of a light source comprising a support frame provided with through holes.

FIG. 5b is a schematic side view of a light guide arrangement according to a fifth embodiment and is showing a cross section of a light guide where the light source of FIG. 5a is positioned in a recess and attached to the light guide by stitched wires.

FIG. 6 is a schematic side view of a light guide arrangement according to a sixth embodiment and is showing a cross section of a light guide where a light source is positioned in a through hole and attached to the light guide by stitched wires.

FIG. 7 is a schematic top view of a light guide arrangement according to a seventh embodiment where crossed wires are stitched via underlying light source sites and where the wires are provided in a pattern that is non-obstructive for underlying out coupling structures.

FIG. 8 is a flow chart describing a method according to an embodiment

### DESCRIPTION OF PREFERRED EMBODIMENTS

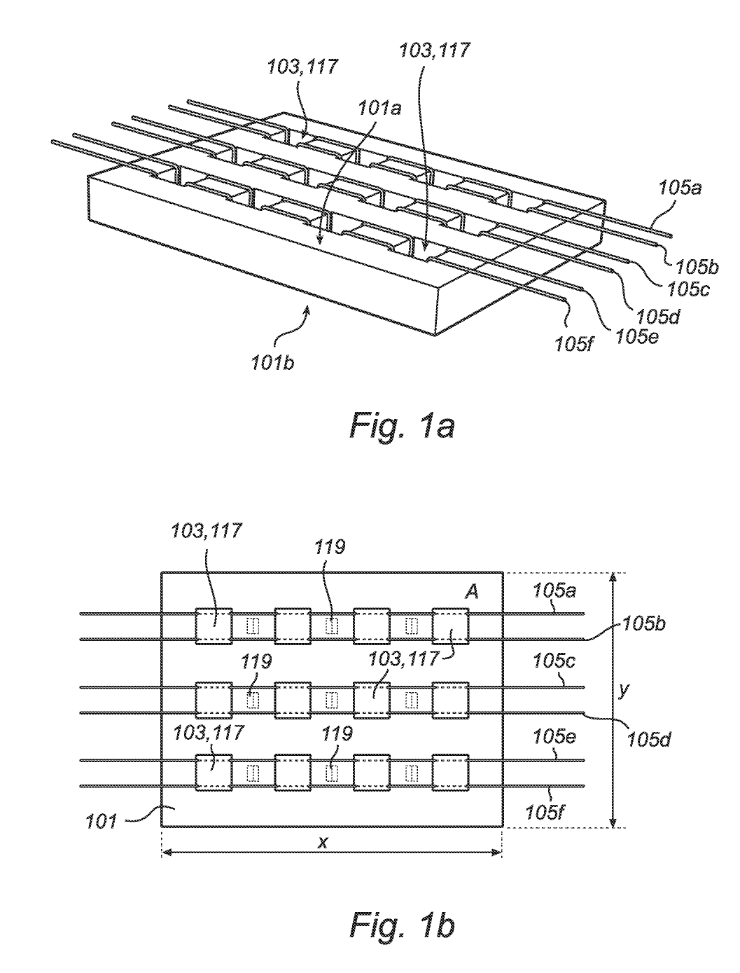

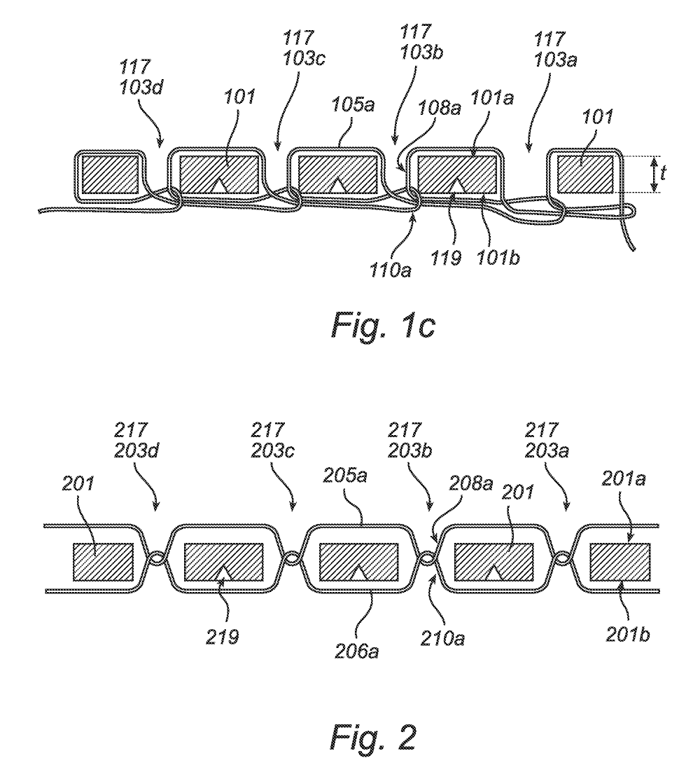

FIG. 1a shows in perspective a schematic view in of a light guide arrangement according to a first embodiment. Parallel electrical wires 105a-f are stitched to a sheet shaped light guide 101 via light source sites 117 that are in the form of through holes 103. The through holes extends between two major surfaces 101a, 101b of the light guide. The surfaces are at opposite sides of the light guide. The light source sites are adapted for light sources so that these, when positioned at the sites, emit light into the light guide. The light guide is transparent to the emitted light and can be of for example PMMA or PC. There are three pairs of parallel wires, each pair provided along their own sequence of through holes. Each sequence is here constituted of consecutive through holes arranged in a straight line or row, and the sequences are in a parallel interrelationship.

FIG. 1b is a schematic top view of the light guide arrangement in FIG. 1 where there is also shown underlying out coupling structures 119, outlined with dotted lines, which are positioned between light source sites. The light guide has an area A and is rectangular with sides of length x and y. The out coupling structures directs light out from the light guide.

FIG. 1c is a schematic side view of the light guide arrangement in FIG. 1 and is showing a cross section of the light guide and one stitched electrical wire 105a. The out coupling structures 119 are in the form of recesses in the light guide and formed as wedges that presents reflecting facets for light that is traveling in the light guide. In order to reflect light that travels parallel to the major surfaces out from one of these surfaces, here 101a, in a perpendicular relationship, the facets are facing the light at an angle of 45 degrees.

The light guide has a thickness t. In general, the area of a major surface, and the side lengths thereof, are typically large in comparison to the thickness, such as 10 times larger or more, i.e. the light guide typically has a thin structure. For example, the thickness may be 1-100 mm, side lengths 0.1-5 m and the area 10 cm² to 10 m². There can be up to one light source site every cm². Thus, the area A of a light guide arrangement comprising 12 light source sites, such as in FIG. 1, can be from about 12 cm².

Further, FIG. 1c shows how wire 105a is stitched to the light guide, here in the form of a chain stitch.

Note that the wire is showed in a slack state for presentational purposes, but it should be readily understood that in a real case the wire would typically be tightened.

In the chain stitch, the wire runs over the major surface 101a and from one through hole to the next, along a sequence of holes 103a-103d. At each through hole in the sequence there is a first portion 108a of the wire that engages with a second portion 110a of the same wire. However, the first portion extends from the first surface 101a and the second portion extends from the opposite surface 101b. In the shown cross section it can be observed that the engagement is taking place at the openings of the through holes at the second surface. The second portion is here in the form of a loop that encircles the first portion. Since the second portion loop is constituted by the wire after it has passed into the next hole in the sequence, the result is that the wire connect to itself in chain like manner.

For example, the wire runs over the first surface 101a along the sequence of holes. It encounters a hole 103b and follows an inner edge through the hole to the opposite second surface, where the wire changes direction and runs back over the opposite surface to a previous hole 103a. It encircles the wire at the previous hole by forming a loop. Then the wire returns, via the second surface, to the hole 103b, where it follows an opposite edge through the hole and is then back at the first surface. Thus, the wire has now passed the hole on the first surface and continues to a next hole 103c in the sequence, where everything repeats, i.e. when the wire goes into the next hole 103c it will, via the second surface, encircle the wire at hole 103b etc.

FIG. 2 is a schematic side view of a light guide arrangement according to a second embodiment and is showing a cross section of a light guide, similar to the one of FIG. 1c but where the electrical wires instead are lock stitched. Since the difference in how the wire is stitched is not visible in FIGS. 1a and 1b, theses may as well apply to the embodiment in FIG. 2.

The shown lock stitch uses two wires running in parallel, a first wire 205a that mainly runs over the first surface 201a and a second wire 206a that mainly runs over the second surface 201b. The wires meet and engage each other at the through holes. A first portion 208a of the first wire 205a extends from a first side of the light guide, here the first surface 201a, and engages with a second portion 210a of the second wire 203b that extends from a second side, here the second surface 201b. The two wires run in parallel like this from one through hole to the next, along the sequence of holes 205a-205d. In the shown cross section it can be observed that the lock stitch is symmetric relative to the wave-guide and that the engagement is taking place inside the holes. However, the engagement can also take place closer to or at the openings of the hole, e.g. depending on how wires are tightened.

For example, the first wire runs over the first surface 201a along the sequence of holes and in parallel, on the opposite side of the light guide, the second wire runs over the second surface 201b. At each through hole the wires crosses each other and then continue to run over the same surface to the next hole in the sequence, where everything repeats.

In an alternative embodiment where lock stitches are used, the two wires 205a, 206a that run at opposite surfaces cross each other at the through holes instead of being parallel.

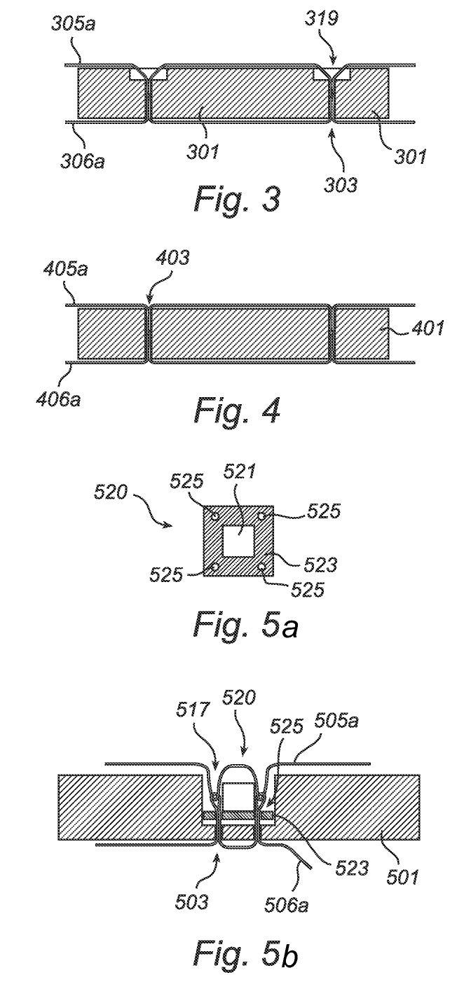

FIG. 3 is a schematic side view of a light guide arrangement according to a third embodiment and is showing a cross section of a light guide 301 where electrical wires 305a, 306a are lock stitched via through holes 303 that have been combined with out coupling structures 319 instead of light source sites. The out coupling structures are in the form of recesses which have been extended with through holes. The out coupling structures are in the form of wedges presenting two opposite facets for reflection of light arriving from the inside of the light guide. Where the facets meet, i.e. at the bottom of the wedge recess, there is formed a groove. The shown cross section is perpendicular to the facets and is thus made along the groove, i.e. the through hole is extending from the groove. When the wires pass the out coupling structures, the wires run along the groove. Thus the wires do not cross the facets. It should be noted that the through hole here has a width that is less than the length of the groove, however, the through hole could as well be as wide as the groove. Also, in an alternative embodiment the wires may cross the facets. Since the facet surface the wires run over are not facing the inside of the light guide, these surfaces are typically not used for reflecting light and thus the wires can cross without affecting the out coupled light.

A perspective view and top view, i.e. corresponding to the views shown for the first embodiment in FIG. 1, have been excluded for the third embodiment. However, it should be readily understood how e.g. a top view corresponding to FIG. 1b would look like in when a the wires are stitched via through holes that are in connection with the out coupling structures.

FIG. 4 is a schematic side view of a light guide arrangement according to a fourth embodiment and is showing a cross section of a light guide where electrical wires 405a, 406a are lock stitched via separate stitch specific through holes. Although there is a risk that such through holes cause undesired out coupling of light, separate through holes may in some situations still be required, for example in order to supplement through holes that are in combination with light source sites and/or out coupling structures. Also, there are typically certain locations at a surface of a light guide where stitch specific through holes can be made with no, or a negligible, disturbance, for example at location in the light guide where there are no or comparatively small amounts of light, or at locations where light, e.g. when the light guide arrangement is used in a luminarie, never will be let out anyway. Such location can be remote from out coupling structures and/or close to light source sites and/or at sides of light source sites where a light source will not emit light.

It should be readily understood that the wire, or wires, can be stitched via stitch specific through holes in a similar manner as previously described when the through holes were combined with light source sites and/or out coupling structures.

FIG. 5a is a schematic top view of a light source 520 comprising a submount frame 523 provided with through holes 525.

FIG. 5b is a schematic side view of a luminaire according to a fifth embodiment and is showing a cross section of a light guide 501 where the light source 520 from FIG. 5a is positioned in a light source site 517. The light source site is here in the form of a recess which has been extended with through holes 503. The light source through hole 525 and the light guide through holes 503 cooperate when the light source is positioned at the light source sites. When the light source is in its intended position 517 at the light guide, the respective through holes 503, 525 form a common through hole at which wire portions may engage in a similar manner as previously was described for light guide arrangements without light sources. FIG. 5b shows a lock stitch involving wires 505a, 506a. Hence, the wires now also securely attach the light source to the light guide.

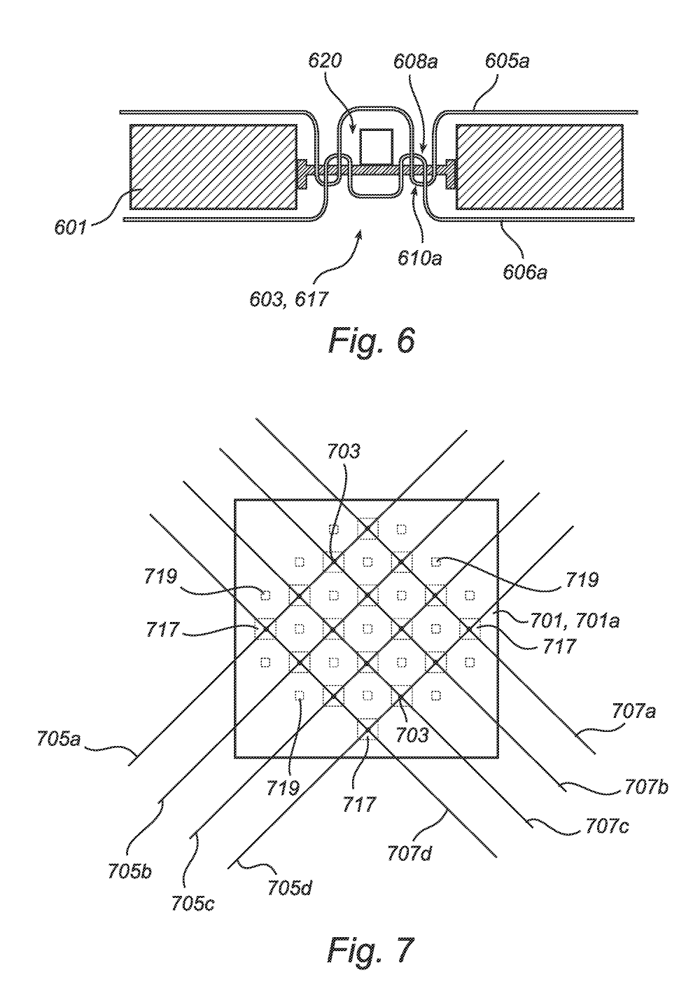

FIG. 6b is a schematic side view of a luminaire according to a sixth embodiment and is showing a cross section of a light guide 601 where a light source 620 is positioned in a light source site 617, which here is in the form of a through hole 603. Instead of being prepared with through holes in advance, the through holes in the submount frame are here being formed in situ when the wires are being stitched. There is created a through hole of at least the cross section area of the wire each time wire portions 608a and 610a passes through the submount frame. Here two lock stitches are used, one on each lateral side of the light source, and eight light source through holes are created in the submount frame. Also, from the figure it can be seen that engagements between wire portions are taking part at the through hole 603 and on the surface of the sub mount frame. This embodiment is also an example of a situation where one light guide through hole cooperates with multiple light source through holes.

In other embodiments stitched wires connect other types of components to the light guide. Such other components may for example include additional optical components, such as optical plates, electronic components, other wires etc. A non-conducting or insulating wire can e.g. be used to attach a conducting wire.

In one embodiment the wires being stitched to the light guide connect and attach a stack of optical components. This may e.g. be the case in luminaries comprising multilayered optical structures, such as a stack of parallel light guides and/or other types of optical plates.

Stitched electrically conducting wires may be e.g. be used to supply electrical power and or signals to components, including light sources.

In alternative embodiments, non-conducting wires can be used for pure fastening purposes. However, note that wires may be electrically conducing and still used only for fastening purposes. In such cases the electrically conducting wire, of course, do not have to be connected to an electrical signal or power source.

Note also that the same electrical wire may be used to provide electrical power or signals to some components, while it is only, or also, used for attaching other components.

In a luminarie the light sources may be electrically connected to electrically conducting wires by conventional methods. Electrical connections between wires and light sources may for example involve soldering techniques or ultrasonic methods. In case of soldering a reflow oven can be used, or the soldering may be performed by locally heating the solder, by e.g. laser. Local heating is typically preferred when the light guide is made of a material that cannot withstand high temperatures, such as can be the case in a reflow oven.

FIG. 7 is a schematic top view of a light guide arrangement according to a seventh embodiment. Crossed electrical wires in two sets, 705a-d, 707a-d are stitched to a light guide 701 via underlying light source sites 717. Wires within each of the two sets are parallel. The sets cross at an angle, here approximately 90 degrees, but also other angles may be used. The wires are here provided in a symmetrical pattern that is non-obstructive for underlying out coupling structures 719, i.e. the wire do not pass over a light source site. The view shows a first surface 701a of the light guide and wires. Wires, or portions of the wires, running at the opposite side, e.g. at the second surface, are not shown. The wires may e.g. be chain stitched and/or lock stitched. In case of a lock stitch there is thus provided 4 electrically separated wires at each light source site. In case any of these wires are cut at the light source site there is provided one more, i.e. the arrangement of FIG. 7 may provide up to 8 separate electrical connections at a light source site. In embodiments where even more wires are crossed, or grouped together, the number of electrical connections may increase by up to 4 per wire. When chain stitches are used there is typically a reduction to half the number of connections.

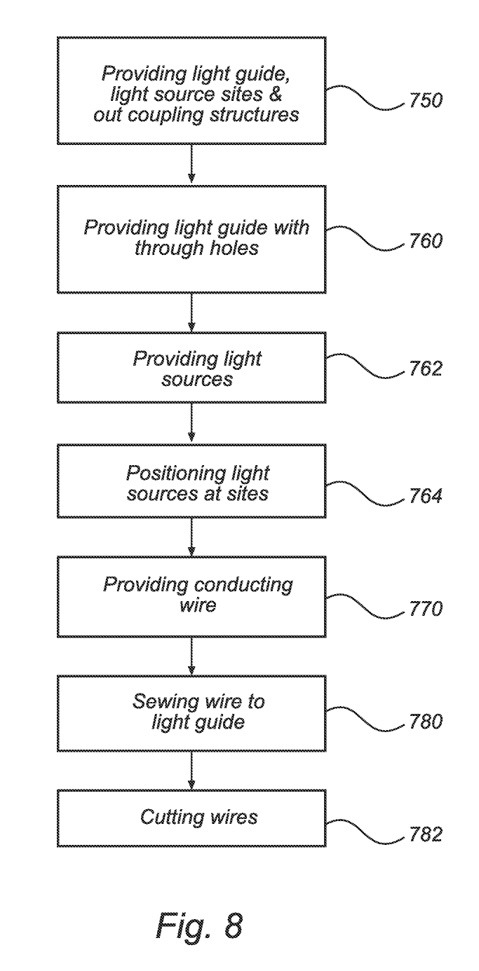

FIG. 8 is a flow chart describing a method for providing electrically conducting wires to a light guide arrangement for multiple light sources according to an embodiment. In a first step 550 a light guide, light source sites and out coupling structures are provided. These may e.g. correspond to what has been shown in connection with any of the previously shown embodiments. In a next step 560, the light guide is provided with through holes. In alternative embodiments this step can be combined with step 550, e.g. when the light source sires and/or out coupling structures are combined with through holes. After step 560, light sources are provided in a step 762 and positioned at the light source sites in a following step 764. The light sources are arranged to cooperate with the through holes in the light guide, for example as was described in connection with FIG. 5b or FIG. 6. In a step 770, at least one electrically conducting wire is provided. Each wire is then, in a step 780, sewed to the light guide, i.e. stitches are accomplished, for example as has been described above. The wires are sewed so that wires are provided at the light source sites, for example sewed so that wires are being provided according to any of the previously described embodiments. Since the light sources are present and cooperates with the through holes in the light guide, both the light sources and the wires are attached to the light guide in this step. In alternative embodiments, step 762 and 764 may be missing, and then, of course, only the wire is being attached in step 780. After the wires have been attached, in a step 782, a wire, or wires, are cut, preferably close to a light source site. In alternative embodiments step 782 may be missing. Also, in other embodiment there may be steps following where light sources are positioned and/or attached at the sites and the light sources may be electrically connected to the wires, for example using any of the previously described techniques.

In other embodiments, other components than light sources are be attached using the wires, preferably during the sewing step.

While the invention has been illustrated and described in detail in the drawings and foregoing description, such illustration and description are to be considered illustrative or exemplary and not restrictive; the invention is not limited to the disclosed embodiments.

For example, it is possible to operate the invention in an embodiment where the stitched wires are not electrical conducting, where some wires are electrically conducting and others are not, where electrically conducing wires are connected to many different power and/or signal sources, where other types of stitches than lock stitches or chain stitches are used, where there is more than two parallel wires per through hole, where sequences of through holes that a wire passes are not comprising only consecutive neighboring through holes, but where instead some, e.g. every second, through hole is being omitted in the sequence, where the sequences are not forming straight lines but instead are changing direction, e.g. are forming a zigzag pattern, a helix, an arc, or some other geometrical pattern, where wires belonging to a sequence are not parallel, but instead e.g. twisted or crossed, where a sequence have one or many through holes common with another sequence, where conducting wires are combined with non-conducting wires e.g. for fastening and/or decorative purposes, where the wires are provided in other symmetrical, or unsymmetrical, patterns than what here has been shown, where the wires are provided so as to accomplish predetermined patterns in a luminous flux provided by a luminarie employing the light guide arrangement, where wires crosses at other locations than at light source sites, where different types of through holes are mixed, e.g. where through holes combined with light source sites are mixed with through holes combined with out coupling structures and/or mixed with stitch specific through holes, where other components than light sources are attached to the light guide by the wires, where the wires are attaching layers in a stack of optical components, such as optical plates, comprising the light guide, where the light guide, and/or one or both of the major surfaces, may be wholly or partly curved, e.g. concave or convex, where one or two of the major surfaces may wholly or partly be uneven, e.g. rugged and/or indulging, where the light guide has a varying thickness, where one of the major surfaces are light absorbing, where light source sites have other geometrical shapes, e.g. are circular, rectangular etc, or have any other arbitrary shape that allow for positioning of light sources at the sites so that the light sources can emit light, directly or indirectly, into the light guide, where out coupling structures are placed at other locations in the light guide, have other shapes and/or sizes, e.g. are cone shaped instead of wedge like etc, where out coupling structures present more or less facets, present facets at different angles, where out coupling structures reflect light out from the light guide in different directions, where out coupling structures direct light out through both major surfaces of a flat light guide, where out coupling structures comprise a reflecting part and/or material that is not part of the light guide per se, with or without involving recesses in the light guide, etc.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. Any reference signs in the claims should not be construed as limiting the scope.

1. A light guide arrangement, comprising
a light guide defining:
a plurality of through holes extending between a first side and an opposite second side of said light guide, and
a plurality of recesses for receiving light sources therein such that said light sources emit light into said light guide; said light guide comprising:
out coupling structures arranged at said light guide and adapted to direct light out from said light guide; and
at least one wire disposed along a sequence of said through holes, wherein, at each through hole in said sequence, a first wire portion extends from said first side and is in engagement with a second wire portion extending from said second side, said through holes and said wire being adapted to enable attachment of said light sources at least partially within said recesses.

2. The light guide arrangement as claimed in claim 1, wherein said wire is electrically conducting.

3. The light guide arrangement as claimed in claim 1, wherein the first wire portion and the second wire portion belong to the same wire.

4. The light guide arrangement as claimed in claim 1, wherein the first wire portion and the second wire portion belong to different wires.

5. The light guide arrangement as claimed in claim 1, comprising two wires that cross each other.

6. The light guide arrangement as claimed in claim 5, wherein the wires cross each other at least one recess of the plurality of recesses.

7. (canceled)

8. The light guide arrangement as claimed in claim 1, wherein the through holes are adjacent to the recesses.

9. The light guide arrangement as claimed in claim 1, wherein the recesses are the through holes.

10. The light guide arrangement as claimed in claim 1, wherein the through holes are associated with the outcoupling structures.

11. A luminaire comprising the light guide arrangement as claimed in claim 1, wherein the light sources are positioned at least partially within the recesses.

12. The luminaire as claimed in claim 11, wherein the light sources define through holes arranged to cooperate with the through holes in the light guide.

13-15. (canceled)
